(19) United States
(12) Patent Application Publication
(10) Pub. No.: US 2021/0033102 A1
(43) Pub. Date: Feb. 4, 2021

(54) HIGH-AIRFLOW BLOWER FAN INCLUDING NON-EQUIDISTANT BLADES

(71) Applicant: IM Co., Ltd., Jeollabuk-do (KR)

(72) Inventor: Yeol Gyu Sung, Jeollabuk-do (KR)

(21) Appl. No.: 16/568,436

(22) Filed: Sep. 12, 2019

(30) Foreign Application Priority Data
Jul. 29, 2019 (KR) 10-2019-0091505

(51) Int. Cl. F04D 29/28

(52) U.S. Cl. CPC F04D 29/281

(57) ABSTRACT

A high-airflow blower fan including an impeller having a mounting hole in which a driving motor is mounted, and a pair of blades repeatedly disposed on an upper surface and a lower surface of the impeller at a first interval along a radial direction, wherein the pair of blades includes a first blade configured to extend with a curvature in an inner direction from an outer circumference of the impeller, and a second blade disposed to be spaced apart from the first blade at a second interval in a clockwise direction or in a counterclockwise direction and configured to extend relatively smaller than a radial length of the first blade in an inner radial direction from the outer surface of the impeller.

### CROSS-REFERENCE TO RELATED APPLICATION

This application claims priority of Korean Patent Application No. 10-2019-0091505, filed on Jul. 29, 2019, in the KIPO (Korean Intellectual Property Office), the disclosure of which is incorporated herein entirely by reference.

### BACKGROUND OF THE INVENTION

### Field of the Invention

This disclosure relates to a high-airflow blower fan including non-equidistant blades, and more particularly, to a high-airflow blower fan including non-equidistant blades, which may improve the airflow performance by using an impeller including blades arranged non-equidistantly.

### Description of the Related Art

Drying the hair after washing the hair is very important for maintaining a healthy scalp. If the hair is left without being dried after the hair is washed, the scalp may get wet and bacteria may grow thereon. In addition, the damp scalp environment of the scalp may cause an unpleasant hair odor by allowing the growth of various bacteria and other fungi as well as dandruff coli. Moreover, the damp scalp environment may also cause hair loss.

In order to prevent this phenomenon, it is necessary to dry the hair using a hair-dryer after the hair is washed.

Meanwhile, the hair-dryer is a product for drying wet hair by cold or hot air, and includes a body having a blower fan, a grip with a switch, a blowing tube induction path, and a coil heater fixed in the blowing tube induction path. If power is applied, the hair-dryer operates to rotate the blower fan. If hot air is desired, the hair-dryer heats a coil heater, and if cold air is desired, the hair-dryer does not heat the coil heater.

However, the hair-dryer including such a general blower fan needs to apply hot air for a long time to dry the entire hair sufficiently. However, if the scalp is exposed to hot air for a long time, the hot air may cause damage to the scalp. For this reason, there is an increasing need for a fan for hair-dryer that may dry hair quickly within a short time.

### SUMMARY OF THE INVENTION

This disclosure is directed to providing a high-airflow blower fan including non-equidistant blades, which may improve the airflow performance by using an impeller including blades arranged non-equidistantly.

The object of the present disclosure is not limited to the above, and other objects not mentioned can be clearly understood by those skilled in the art from the description below.

In one general aspect, there is provided a high-airflow blower fan including non-equidistant blades, which is rotated by an impeller and a driving motor for driving the impeller to form an airflow, the high-airflow blower fan comprising: an impeller having a mounting hole in which a driving motor is mounted; and a pair of blades repeatedly disposed on an upper surface and a lower surface of the impeller at a first interval along a radial direction, wherein the pair of blades includes: a first blade configured to extend with a curvature in an inner direction from an outer circumference of the impeller; and a second blade disposed to be spaced apart from the first blade at a second interval in a clockwise direction or in a counterclockwise direction and configured to extend relatively smaller than a radial length of the first blade in an inner radial direction from the outer surface of the impeller, wherein when the pair of blades is arranged in plural at the impeller along the radial direction, the first interval is formed greater than the second interval.

Here, when the second blade extends from the outer circumference of the impeller to an inner circumference thereof, the second blade may extend in the inner direction within the range of 60% to 70% with respect to the radial length of the first blade.

Here, the outer circumference of the impeller may have a tooth shape where a first radius and a second radius relatively smaller than the first radius are repeated in a circumferential direction, and the first blade and the second blade may be formed in the inner direction at the second radius.

In the high-airflow blower fan including non-equidistant blades, the blades composed of a first blade and a second blade are respectively arranged non-equidistantly at the upper surface and the lower surface of the impeller to increase the pressure and discharge amount of the airflow sucked into each space, thereby providing a hair-dryer capable of drying the hair within a short time.

In addition, since the hair-dryer is used within a shorter time, it is expected to save electricity.

The effect of the present disclosure is not limited to the above, and other effects not mentioned can be clearly understood by those skilled in the art from the description below.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1A is a perspective view showing a high-airflow blower fan including non-equidistant blades according to an embodiment of the present disclosure.

FIG. 1B is a rear view of FIG. 1A.

FIG. 2 is a diagram, observed in a center direction of FIGS. 1A and 1B.

FIG. 3 shows a shape of a blower fan for a dryer, which includes conventional blades, and a flow analysis result thereof.

FIG. 4 shows a shape of the high-airflow blower fan including non-equidistant blades according to an embodiment of the present disclosure, and a flow analysis result thereof.

FIG. 5 is a graph comparatively showing average airflows of the present disclosure and a comparative example.

FIG. 6 is a photograph of an experiment for comparing the rising heights of a ping-pong ball according to the present disclosure and the comparative example.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

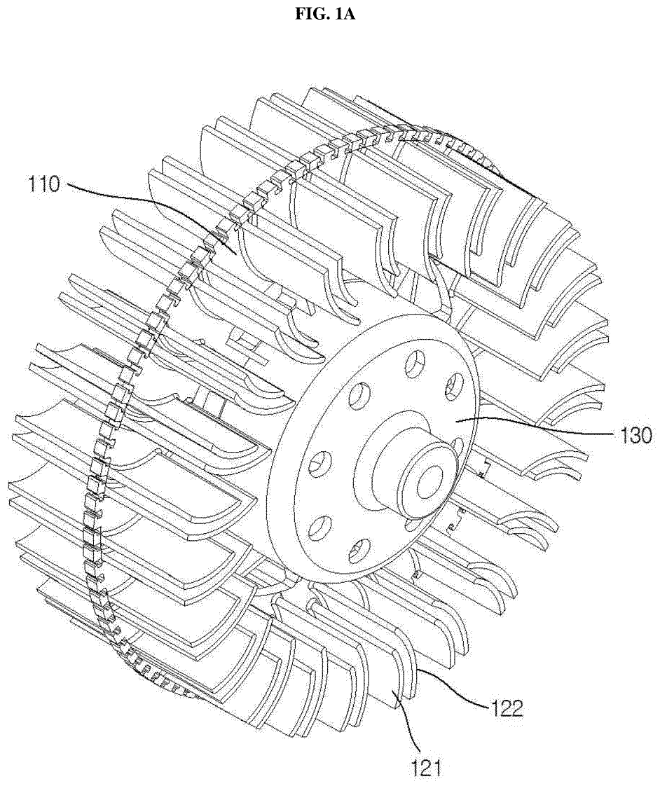

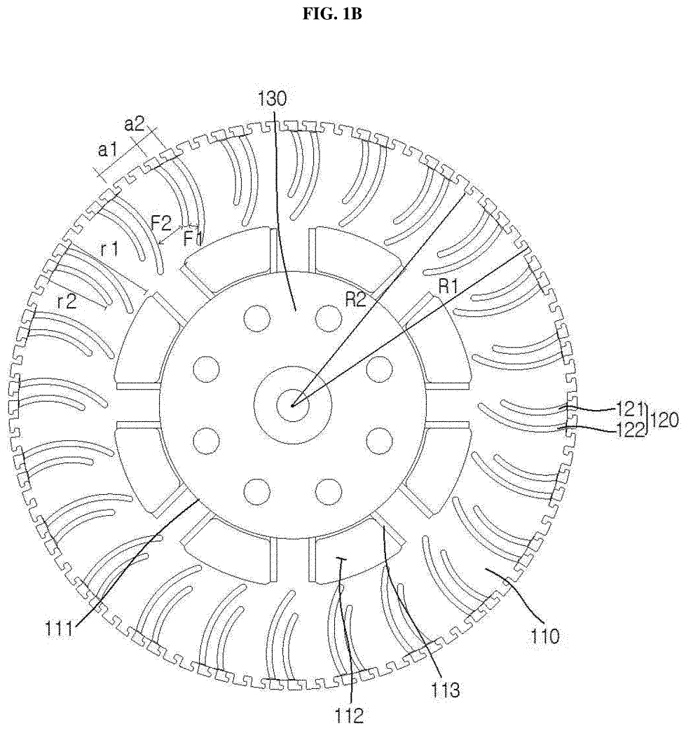

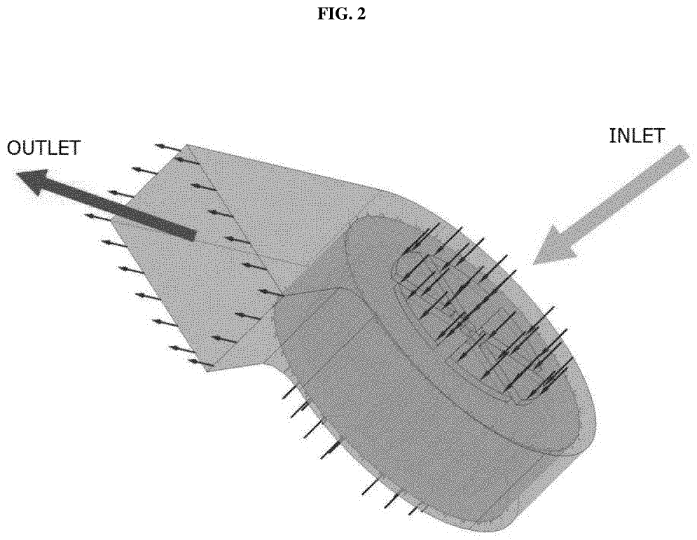

FIG. 1A is a perspective view showing a high-airflow blower fan including non-equidistant blades according to an embodiment of the present disclosure, FIG. 1B is a rear view of FIG. 1A, and FIG. 2 is a diagram, observed in a center direction of FIGS. 1A and 1B.

Referring to FIGS. 1A, 1B, and 2, a high-airflow blower fan including non-equidistant blades according to an embodiment of the present disclosure may be used for a hair-dryer and includes an impeller 110 and blades 120. Hereinafter, it is described that the high-airflow blower fan including non-equidistant blades according to the present disclosure is mounted to a hair-dryer. However, without being limited to the above, the high-airflow blower fan of the present disclosure may be applied in various ways for devices such as an air cleaner, an air conditioner, a blower, a cloth dryer and a ventilator, which requires air blowing.

The impeller 110 has a mounting hole 111 formed therein so that a driving motor is mounted thereto, and a driving motor housing 130 is coupled to the impeller 110 to rotate together with the blades 120 coupled to the impeller 110 according to the driving of the driving motor. The driving motor housing 130 may have a plurality of holes formed therein along a radial direction to effectively cool the heat generated by the driving motor to the outside. The impeller 110 is formed to have a first radius R1 and a second radius R2. The second radius R2 is formed relatively smaller than the first radius R1, and the first radius R1 and the second radius R2 are repeatedly formed. At this time, since teeth are formed along the rotational direction, the flow of air discharged forward may be strongly pressed due to the teeth to increase the discharge pressure.

The driving motor is preferably a brush-less direct current motor (BLDC), but the structure of the motor is not limited thereto.

The impeller 110 has a plurality of holes 112 formed outward from the outer circumference of the mounting hole 111 along the radial direction. The holes 112 may have a trapezoidal shape, and impeller supports 113 extending upward from both edge surfaces of the holes 112 may be formed. The impeller support 113 may have a tapered shape so that its height decreases from the inner radius to the outer radius. That is, the impeller support 113 is configured such that its height at the surface in contact with the driving motor housing 130 is greater than the other surface, thereby increasing the rigidity of the shaped impeller 110 having a plate shape. Moreover, the impeller support 113 supports the outer circumference of the driving motor housing 130 to reduce the shaking caused by the vibration of the driving motor disposed at the inside of the driving motor housing 130.

The blades 120 include a first blade 121 and a second blade 122. The first blade 121 and the second blade 122 are repeatedly disposed on the upper surface and the lower surface of the impeller 110 at a first interval a1 along the radial direction.

The first blade 121 is spaced apart from the outer circumference of the hole 112 by a predetermined distance, and is bent in a predetermined direction with a curvature and extended to the second radius r1 of the outer circumference of the impeller 110. The curvature may be formed along the discharge direction to facilitate the flow of air. At this time, a second interval a2 is formed differently from the first interval a1.

The second blade 122 is formed with a curvature to be spaced apart from the first blade 121 by a predetermined distance in a clockwise direction or a counterclockwise direction at a second interval a2. In addition, the second blade 122 extends in the radial direction r2 in the inner radial direction from the outer circumference of the impeller 110 with a length relatively shorter than the radial length r1 of the first blade 121.

At this time, the first interval a1 is formed larger than the second interval a2. Preferably, the first interval a1 may be formed 3 to 5 times larger than the second interval a2. As a result, the blades 120 composed of the first blade 121 and the second blade 122 are arranged non-equidistantly with no equal intervals at the impeller 110. By doing so, the width of a first inflow path F1 is formed to be relatively larger than a second inflow path F2. Since the first inflow path F1 and the second inflow path F2 have different widths and are arranged symmetrically on both sides of the impeller 110 as described above, it is possible to increase the discharge effect of air flowing between the first inflow path F1 and the second inflow path F2.

In addition, the blades 121, 122 are formed to have the same thickness, the second interval a2 is preferably formed within 1.8 to 2.2 times compared to the thickness of the blades 121, 122.

The radial length r2 of the second blade 122 of the present disclosure may extend in the range of 60% to 70% of the radial length r1 of the first blade 121 when extending from the outer circumference of the impeller 110 to the inner circumference thereof.

If the second blade 122 is formed over the range of 70%, the sizes of the first inflow path F1 and the second inflow path F2 are reversed. If the sizes of the first inflow path F1 and the second inflow path F2 are reversed as above, the advantages obtained by the aforementioned non-equidistant structure disappear. On the contrary, if the second blade 122 is formed less than 60%, the flow of air flowing between the first blade 121 and the second blade 122 is decelerated to reduce the effect of increasing the discharge, thereby failing to effectively increasing the airflow.

That is, when the radial length r2 of the second blade 122 of the present disclosure extends from the outer circumference of the impeller 110 to the inner circumference thereof, the radial length r2 is in the range of 60% to 70% of the radial length r1 of the first blade 121.

Hereinafter, the high-airflow blower fan including non-equidistant blades according to an embodiment of the present disclosure will be described in comparison to a conventional technique, Comparative examples 1-3.

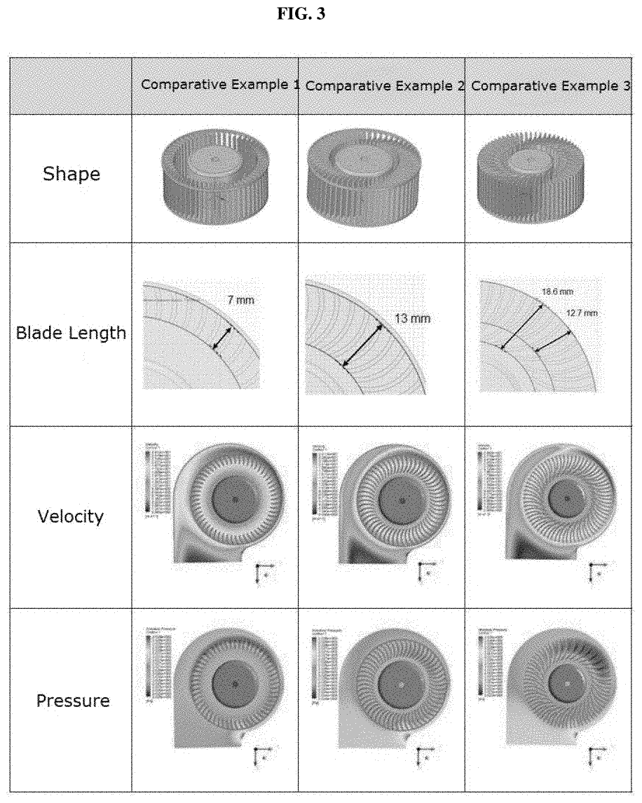

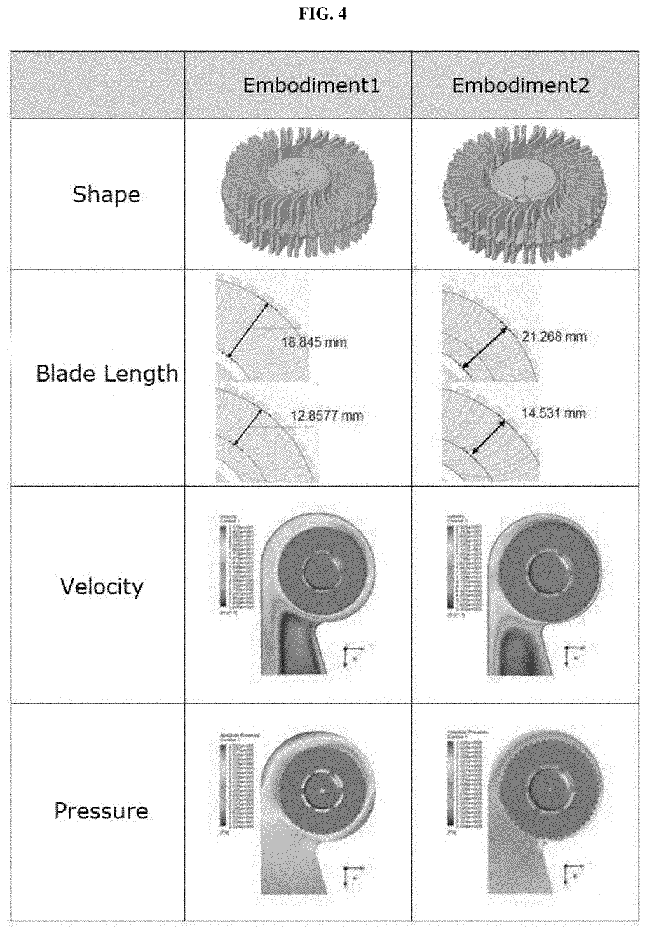

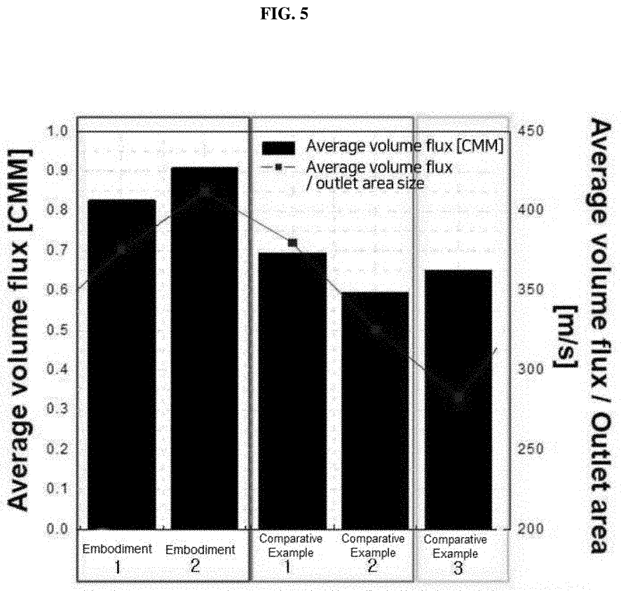

FIG. 3 shows a shape of a blower fan for a dryer, which includes conventional blades, and a flow analysis result thereof, FIG. 4 shows a shape of the high-airflow blower fan including non-equidistant blades according to an embodiment of the present disclosure, and a flow analysis result thereof, and FIG. 5 is a graph comparatively showing average airflows of the present disclosure and comparative examples 1-3.

As shown in the comparative examples of FIG. 3, in the comparative examples, blades having the same shape are arranged at equal intervals along the radial direction. Meanwhile, in the present disclosure (Embodiments 1 and 2), the blades are arranged non-equidistantly along the radial direction on the upper surface and the lower surface of the impeller, respectively. Here, in Embodiments 1 and 2, the impeller has diameters of 80 mm and 90 mm, respectively, and blades are arranged non-equidistantly on both surfaces of the impeller so that the first inflow path and the second inflow path have different widths.

If the blades are formed non-equidistantly as in Embodiments 1 and 2 so that the first inflow path and the second inflow path have different widths, it has been found that the average volume airflow may be increased by more than 50%, compared to the case where blades are arranged constantly in the circumferential direction (Comparative examples).

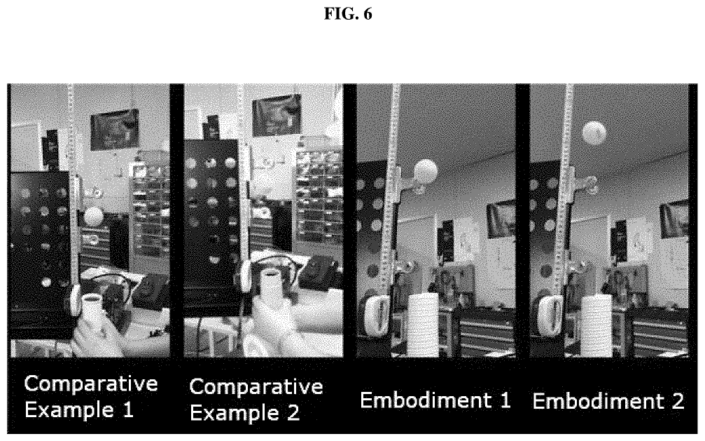

In addition, as a result of comparing the rising height of a ping-pong ball to compare the discharge pressure, it could be found that the ping-pong ball may rise up to 65% or higher in comparison to the comparative example and thus the discharge pressure is increased (see FIG. 6).

In the high-airflow blower fan including non-equidistant blades according to the present disclosure, the blades composed of a first blade and a second blade are respectively arranged non-equidistantly at the upper surface and the lower surface of the impeller to increase the pressure and discharge amount of the airflow sucked into each space, thereby providing a hair-dryer capable of drying the hair within a short time.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A high-airflow blower fan including non-equidistant blades, which is rotated by an impeller and a driving motor for driving the impeller to form an airflow, the high-airflow blower fan comprising:
an impeller having a mounting hole in which a driving motor is mounted; and
a pair of blades repeatedly disposed on an upper surface and a lower surface of the impeller at a first interval along a radial direction, the pair of blades comprising:
a first blade configured to extend with a curvature in an inner direction from an outer circumference of the impeller; and
a second blade disposed to be spaced apart from the first blade at a second interval in a clockwise direction or in a counterclockwise direction and configured to extend relatively smaller than a radial length of the first blade in an inner radial direction from the outer surface of the impeller,
wherein when the pair of blades is arranged in plural at the impeller along the radial direction, the first interval is formed greater than the second interval.

2. The high-airflow blower fan including non-equidistant blades of claim 1, wherein when the second blade extends from the outer circumference of the impeller to an inner circumference thereof, the second blade extends in the inner direction within the range of 60% to 70% with respect to the radial length of the first blade.

3. The high-airflow blower fan including non-equidistant blades of claim 1,
wherein the outer circumference of the impeller has a tooth shape where a first radius and a second radius relatively smaller than the first radius are repeated in a circumferential direction,
wherein the first blade and the second blade are formed in the inner direction at the second radius.

4. A high-airflow blower fan including non-equidistant blades comprising:
an impeller having a mounting hole in which a driving motor is mounted; and
a pair of blades repeatedly disposed on an upper surface and a lower surface of the impeller at a first interval along a radial direction, the pair of blades comprising:
a first blade configured to extend with a curvature in an inner direction from an outer circumference of the impeller; and
a second blade disposed to be spaced apart from the first blade at a second interval in a clockwise direction or in a counterclockwise direction and configured to extend relatively smaller than a radial length of the first blade in an inner radial direction from the outer surface of the impeller.

5. The high-airflow blower fan including non-equidistant blades of claim 4, wherein when the second blade extends from the outer circumference of the impeller to an inner circumference thereof, the second blade extends in the inner direction within the range of 60% to 70% with respect to the radial length of the first blade.

6. The high-airflow blower fan including non-equidistant blades of claim 4,
wherein the outer circumference of the impeller has a tooth shape where a first radius and a second radius relatively smaller than the first radius are repeated in a circumferential direction,
wherein the first blade and the second blade are formed in the inner direction at the second radius.
